(19) United States
(12) Patent Application Publication
(10) Pub. No.: US 2011/0137555 A1
(43) Pub. Date: Jun. 9, 2011

(54) International Address System

(76) Inventor: David M Schardt, Milwaukee, WI (US)

(21) Appl. No.: 12/632,153

(22) Filed: Dec. 7, 2009

(51) Int. Cl. G01C 21/00

(52) U.S. Cl. 701/207

(57) ABSTRACT

The International Address System identifies a location with a combination of 10 alphanumeric digits and does not need the input of the numeral zero or cardinal directions (N, S, E, W) to determine the location with 129 square feet of accuracy or less.

### CROSS-REFERENCE TO RELATED APPLICATIONS

Not Applicable

### BACKGROUND/TECHNICAL FIELD OF THE INVENTION

This invention relates generally to navigation and the Global Positioning System (GPS).

Current technology/manufacturing uses the various forms of latitude and longitude (lat/long) or an area's postal address system to locate a position on the earth.

Usage-wise, lat/long are not frequently used by the lay person to locate a position due to several factors. One factor is the complexity of the lat/long number system. It generally takes 17 or more digits to locate a position on the earth and also uses cardinal directions (north, south, east, and west) which can be intimidating and disorienting for many users. Another complexity lies in the precision of the current systems. The number and values of the various lat/long digits changes frequently from destination to destination within a relatively small area.

If one is attempting to locate a position anywhere on the earth, the postal address systems currently in place for individual cities have several shortcomings. The most obvious among these is a lack of standardization between cities and even within a city itself. This causes complication and errors in locating a position. Also, these address systems generally do not provide enough accuracy to locate loading docks or separate entrances at large facilities. Occasionally, the actual postal address of a building may be a relatively long distance from the entrance of the facility. These postal address systems do not allow for the location of many sites (parking lots, tennis courts, hunting or camping spots, etc.). and these systems do not effectively locate new construction if media is not updated. When using current postal address systems, one must also input a large quantity of data (state, city, zip code, street, street number) into navigation sources to locate a position, which can be time-consuming and frustrating.

### BRIEF SUMMARY OF THE INVENTION

The international address system assigns a unique value (address of location) based on the intersection of 5 digits for south to north (S/N) coordinates and 5 digits for east to west (E/W) coordinates. This address provides the end user with a more user-friendly, efficient way to communicate, locate, and navigate to an actual, physical location.

### BRIEF DESCRIPTION OF VIEWS OF THE DRAWING

Not Applicable

### DETAILED DESCRIPTION OF THE INVENTION

The International Address System consists of a combination of 10 alpha/numeric digits. The first 5 digits represent the S/N coordinate. The first digit divides the earth into five 36-degree sections with the axis at the center of the earth. These sections are labeled with the capital letters A-F and go from the South Pole to North Pole. The second digit is determined by dividing each 36-degree section by 35. The 3^{rd} digit is determined by dividing each resulting section by 35 again. The fourth digit is determined by dividing the previously generated section by 35 one more time. Each unit of 35 sections is then assigned a capital letter of A-Z (0=A) and then a numeric value of 1-9 (1=26), respectively. The fifth digit is determined by dividing section represented by the 4^{th} digit by 26 and assigning each of these 26 sections a capital letter from A-Z, respectively. The S/N coordinate will always begin and end with a capital letter.

The 6-10^{th} digits represent the E/W coordinate. The 6^{th} digit divides the earth into eight 45-degree sections with the axis from the South Pole to North Pole. These sections are labeled with the numbers 1-8 and go east starting from the prime meridian. As detailed above for the 2^{nd}-4^{th} digits, each of resulting section is then divided by 35 and then assigned a lower case letter A-Z (0=A) and then 1-9 (1=26) to produce the 7^{th} through 10^{th} digits. The E/W will always begin with a numeric value.

What is claimed is:

1. A 10-digit International Address System comprised of letters and numbers to identify a location with a minimum accuracy within 129 square feet.

2. An International Address System that does not need the input of S/N or E/W to determine a location.

3. An International Address System where one set of coordinates starts and ends with an alphabetic character (A-Z) and the second set of coordinates begins with a numeric character (1-8).

4. An International Address System of claim 1, that does not need the input or display of the numeral zero.
